(19) United States
(12) Patent Application Publication
(10) Pub. No.: US 2011/0112731 A1
(43) Pub. Date: May 12, 2011

(54) CRANE APPARATUS

(76) Inventor: Hidekazu Harada, Oita (JP)

(21) Appl. No.: 12/935,280

(22) PCT Filed: Mar. 27, 2009
(86) PCT No.: PCT/JP2009/056252

§ 371 Date: Dec. 17, 2010

(30) Foreign Application Priority Data
Mar. 31, 2008 (JP) 2008-094231

(51) Int. Cl. B66C 13/14; G06F 7/00

(52) U.S. Cl. 701/50; 212/284

(57) ABSTRACT

A power storage device (first power storage device) (41) stores part of a supply power, and in case of shortage of the supply power, discharges the storage power to compensate for the supply power. A power storage device (second power storage device) (42) stores part of the supply power, and discharges the storage power at least in a cargo lifting operation by motors to compensate for the supply power. As the power storage device (42), a power storage device having an output density higher than that of the power storage device (41) is used. Alternatively, as the power storage device (41), a power storage device having an energy density higher than that of the power storage device (42) is used.

### TECHNICAL FIELD

The present invention relates to a crane apparatus and, more particularly, to a gantry crane apparatus for handling containers at a container terminal by driving motors.

### BACKGROUND ART

A gantry crane apparatus for performing cargo handling to, e.g., load/unload containers on/from a ship or trailer at a container terminal lifts or lowers cargo, and also performs gantry traveling or traversing using a plurality of motors. One of schemes of supplying a power to these motors is an engine driven power generation scheme. The engine driven power generation scheme is designed to generate a necessary power using an engine generator that drives a power generator by a diesel engine, and supply the power to each motor. Another scheme of supplying a power to the motors is a ground feed scheme. The ground feed scheme is designed to install a power supply device in each of lanes partitioned in advance at a container terminal, and supply a source power from the power supply device to each motor.

Such a crane apparatus operates at the maximum load when, e.g., lifting cargo. However, the operation of, e.g., lowering cargo rarely needs a power. That is, the load largely varies. To supply a power suitable for the maximum-load operation, a large-scale power supply system including an engine generator and a power supply device is necessary. This makes the system scale more than the average load, resulting in inefficiency in terms of facility cost and operating cost.

There is conventionally provided a crane apparatus including a power storage device, which always causes an engine generator to generate a power. The apparatus parallelly supplies a power from the power storage device in case of shortage of the supply power, and stores an extra power generated upon regeneration in the power storage device (for example, see Japanese Patent Laid-Open No. 2001-163574). Since the power storage device temporarily supplies a power to the motors, the scale of the diesel engine or power generator can be reduced so as to improve the efficiency in terms of facility cost and operating cost.

### DISCLOSURE OF INVENTION

### Problem to be Solved by the Invention

However, since this prior art uses one power storage device to supply a power, the scale of the power storage device becomes large.

In the crane apparatus, normally, the load power is maximized during cargo lifting and, more particularly, for a relatively short period the rotation of the motors accelerates. When the crane itself travels, a predetermined load power is generated for a relatively long period.

However, the operation, characteristic of a secondary cell used in a power storage device changes depending on the operation principle and the power storage structure. The output density and the energy density tend to contradict each other. For example, a capacitor and a lithium ion cell have a high output density and a low energy density. They can output a large power during a short period, but cannot stably output a power for a long time. A sodium cell has a high energy density but a relatively low output density. It can stably output a power for a long time, but cannot output a large power during a short period. Note that the output density indicates a discharge power per unit volume (unit weight) (W/liter), and the energy density indicates storage energy per unit volume (unit weight) (Wh/liter).

Hence, the power storage device that should compensate for two kinds of load powers of the crane apparatus needs to have both a high output density and a high energy density. This increases the scale of the power storage device.

The present invention has been made to solve this problem, and has as its object to provide a crane apparatus capable of efficiently reducing the scale of a power supply system while suppressing an increase in the scale of a power storage device.

### Means of Solution to the Problem

In order to achieve the above-described object, according to an aspect of the present invention, there is provided a crane apparatus for loading/unloading cargo by driving a plurality of motors, comprising a feed device which supplies, as a supply power, a power to be used for an operation of the crane apparatus, a first power storage device which stores part of the supply power and discharges the storage power when driving the motors, and a second power storage device which stores part of the supply power and discharges the storage power when driving the motors at least for cargo lifting, wherein the second power storage device has an output density higher than that of the first power storage device.

According to another aspect of the present invention, there is provided a crane apparatus for loading/unloading cargo by driving a plurality of motors, comprising a feed device which supplies, as a supply power, a power to be used for an operation of the crane apparatus, a first power storage device which stores part of the supply power and discharges the storage power when driving the motors, and a second power storage device which stores part of the supply power and discharges the storage power when driving the motors at least for cargo lifting, wherein the first power storage device has an energy density higher than that of the second power storage device.

### Effects of the Invention

According to the present invention, the first power storage device stores part of a supply power, and in case of shortage of the supply power, discharges the storage power to compensate for the supply power. A second power storage device stores part of the supply power, and discharges the storage power at least in a cargo lifting operation by motors to compensate for the supply power. As the second power storage device, a power storage device having an output density higher than that of the first power storage device is used. This allows the second power storage device to discharge a large storage power in a short time when lifting cargo.

The same functions as those of an arrangement using only the first power storage device can be implemented by the first and second power storage devices having a smaller volume. It is consequently possible to efficiently reduce the scale of the power supply system while suppressing an increase in the scale of the power storage devices.

When a power storage device having an energy density higher than that of the second power storage device is used as the first power storage device, the first power storage device can stably discharge the storage power for a long time during a period except the period of cargo lifting operation.

The same functions as those of an arrangement using only the second power storage device can be implemented by the first and second power storage devices having a smaller volume. It is consequently possible to efficiently reduce the scale of the power supply system while suppressing an increase in the scale of the power storage devices.

### BRIEF DESCRIPTION OF DRAWINGS

FIG. 1 is a functional block diagram showing the arrangement of a crane apparatus according to the first embodiment of the present invention;

FIG. 2 is a front view showing the arrangement of the crane apparatus according to the first embodiment of the present invention;

FIG. 3 is a side view showing the arrangement of the crane apparatus according to the first embodiment of the present invention;

FIG. 4 is a plan view showing an example of the arrangement of a container terminal;

FIG. 5 is a timing chart showing an example of the operation of the crane apparatus according to the first embodiment of the present invention;

FIG. 6 is a functional block diagram showing the arrangement of a crane apparatus according to the second embodiment of the present invention;

FIG. 7 is a front view showing the arrangement of the main part of the crane apparatus according to the second embodiment of the present invention;

FIG. 8 is a side view showing the arrangement of the main part of the crane apparatus according to the second embodiment of the present invention;

FIG. 9 is a plan view showing an example of the arrangement of a container terminal;

FIG. 10 is a timing chart showing an example of the operation of the crane apparatus according to the second embodiment of the present invention;

FIG. 11 is a functional block diagram showing the arrangement of a crane apparatus according to the third embodiment of the present invention;

FIG. 12 is a front view showing the arrangement of the main part of the crane apparatus according to the third embodiment of the present invention;

FIG. 13 is a side view showing the arrangement of the main part of the crane apparatus according to the third embodiment of the present invention;

FIG. 14 is a plan view showing an example of the arrangement of a container terminal;

FIG. 15 is a plan view showing the arrangement of the current collector of the crane apparatus according to the third embodiment of the present invention;

FIG. 16 is a sectional view showing the arrangement of the current collector of the crane apparatus according to the third embodiment of the present invention taken along a line XVI-XVI;

FIG. 17 is a timing chart showing an example of the operation of the crane apparatus according to the third embodiment of the present invention; and

FIG. 18 is a timing chart showing an example of the operation of a crane apparatus according to the fourth embodiment of the present invention.

### BEST MODE FOR CARRYING OUT THE INVENTION

The embodiments of the present invention will now be described with reference to the accompanying drawings.

### First Embodiment

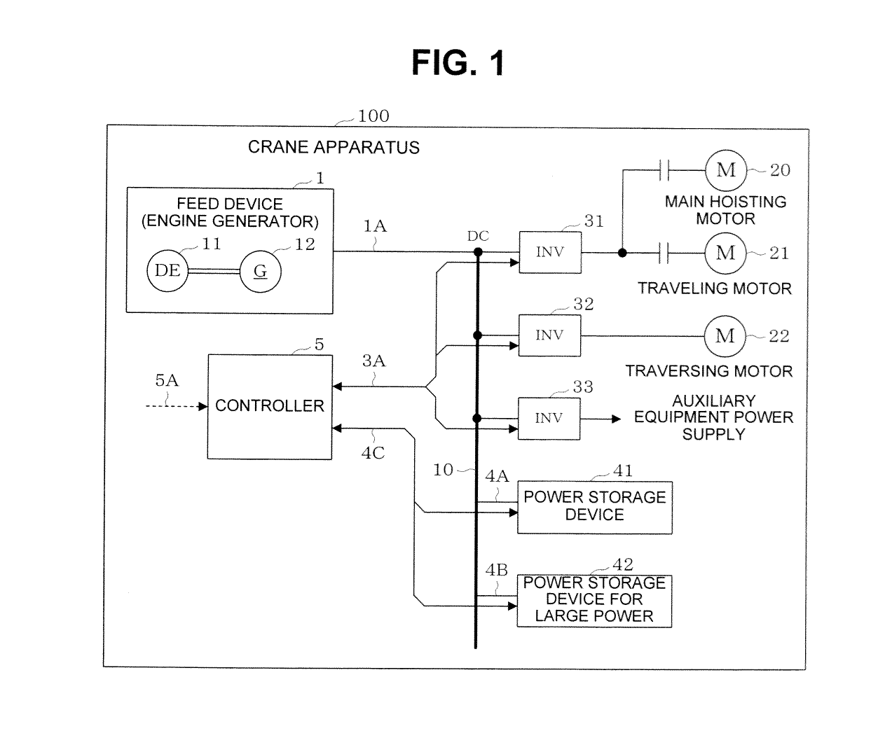

A crane apparatus according to the first embodiment of the present invention will be described first with reference to FIG. 1.

A crane apparatus 100 loads and unloads cargo by driving a plurality of motors. The crane apparatus 100 includes, as main components, a feed device 1, main hoisting motor 20, traveling motor 21, traversing motor 22, inverters (INV) 31 to 33, power storage device (first power storage device) 41, power storage device (second power storage device) 42, controller 5, and common bus 10.

In this embodiment, the feed device 1 supplies a power to be used by the crane apparatus 100 as a supply power 1A. The power storage device (first power storage device) 41 stores part of the supply power 1A, and discharges the storage power to compensate for the supply power 1A in case of its shortage. The power storage device (second power storage device) 42 stores part of the supply power 1A, and discharges the storage power at least in a cargo lifting operation by motors to compensate for the supply power 1A. As the second power storage device, a power storage device having an output density higher than that of the first power storage device is used. Alternatively, as the first power storage device, a power storage device having an energy density higher than that of the second power storage device is used.

The arrangement of the crane apparatus according to this embodiment will be described next in detail. An example will be explained below in which a supply power obtained by causing an engine generator in the feed device 1 to generate a power is supplied as a power to be used for the operation of the crane apparatus including the motors.

The electrical arrangement of the crane apparatus according to this embodiment will be described first with reference to FIG. 1.

The feed device 1 includes an engine generator having a diesel engine (DE) 11 and a DC generator (G) 12, and has a function of generating a DC power by causing the diesel engine 11 to drive the DC generator 12 and supplying a power to be used for the operation of the crane apparatus 100 including the motors 20 to 22 to the common bus 10 as the operating power 1A. An AC generator may be used in place of the DC generator 12 so that an AC power generated by the AC generator is converted into a DC power by a converter formed from an AC/DC converter, and then supplied to the common bus 10.

The main hoisting motor 20 is an AC motor to be used to lift and lower a container.

The traveling motor 21 is an AC motor to be used to for traveling during normal cargo handling in a forward direction X along lanes partitioned in advance at a container terminal and traveling, i.e., right-angled traveling in a right-angled direction Y perpendicular to the lanes when moving to another lane.

The traversing motor 22 is an AC motor to be used to do an operation of transporting a lifted container horizontally along the right-angled direction Y, i.e., traversing.

The inverter 31 is a DC/AC converter which converts the supply power 1A on the common bus 10 into an AC power of frequency corresponding to the rotation speed, and supplies it to the main hoisting motor 20 and the traveling motor 21.

The inverter 32 is a DC/AC converter which converts the supply power A on the common bus 10 into an AC power of a frequency corresponding to the rotation speed, and supplies it to the traversing motor 22.

The inverter 33 is a DC/AC converter which converts the supply power 1A on the common bus 10 into an AC power of a frequency corresponding to the rotation speed, and supplies it as a power for various kinds of auxiliary equipment including a lighting device, air conditioner, and control device such as the controller 5.

The power storage device (first power storage device) 41 and the power storage device (second power storage device) 42 are circuit devices incorporating storage cells, and are connected to the common bus 10 in parallel. The power storage devices 41 and 42 have at least a function of storing part of the supply power 1A on the common bus 10 in the storage cells, and a function of supplying the power stored in the storage cells to the common bus 10. The power storage device 42 also has a function of controlling start (permission) and stop of power storage/discharge based on a command 4C from the controller 5.

A power to be supplied to the common bus 10 includes not only the supply power 1A supplied from the feed device 1 but also a regenerated power supplied from the main hoisting motor 20 to the common bus 10 via the inverter 31 during cargo lowering. Hence, using at least the supply power 1A suffices for storing a power in the power storage devices 41 and 42. In this embodiment, however, a case will be described in which both the supply power 1A and the regenerated power are used to store a power in the power storage devices 41 and 42 in consideration of effective use of the regenerated power. Note that out of the whole power supplied to the common bus 10, a remaining power other than the power to be used by the respective units of the crane apparatus 100 including the motors 20 to 22, i.e., an extra power is stored in the power storage devices 41 and 42 in general. However, an extra power obtained by limiting the power to be used by the respective units of the crane apparatus 100 may be stored in the power storage devices 41 and 42.

A power storage device having an output density higher than that of the power storage device 41 is used as the power storage device 42. Alternatively, a power storage device having an energy density higher than the power storage device 42 is used as the power storage device 41. Note that the output density indicates a discharge power per unit volume (unit weight) (W/liter), and the energy density indicates storage energy per unit volume (unit weight) (Wh/liter). Generally, a power storage device having a high output density can discharge a large storage power per unit volume in a short time, and a power storage device having a high energy density can stably output a storage power per unit volume.

The controller 5 includes a microprocessor such as a CPU and peripheral circuits thereof. The controller 5 has various kinds of functions for controlling the entire crane apparatus 100 by reading out a program from a memory provided in the microprocessor or a peripheral circuit and executing the program so as to make it cooperate with hardware.

As the main functions, the controller 5 has a crane operating function of controlling the inverters 31 to 33 by exchanging various commands 3A based on operator's commands 5A detected via an operation lever or operation switch so as to control operations such as cargo lifting/lowering, gantry traveling, traversing, and right-angled traveling, and a discharge control function of outputting a command 4C to the power storage device 42 upon detecting input and input stop of the command 5A representing a lifting command by an operator's operation so as to instruct discharge start (discharge permission) and discharge stop.

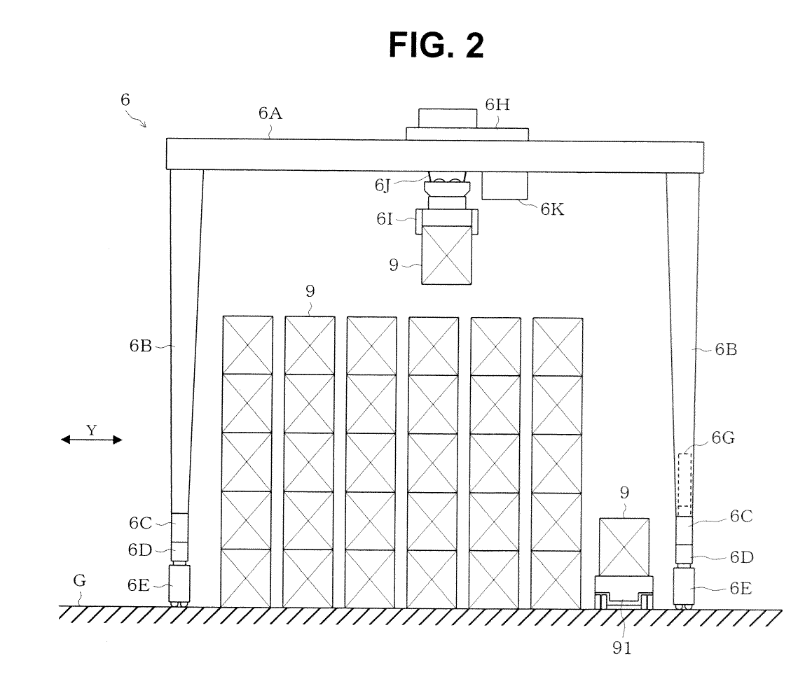

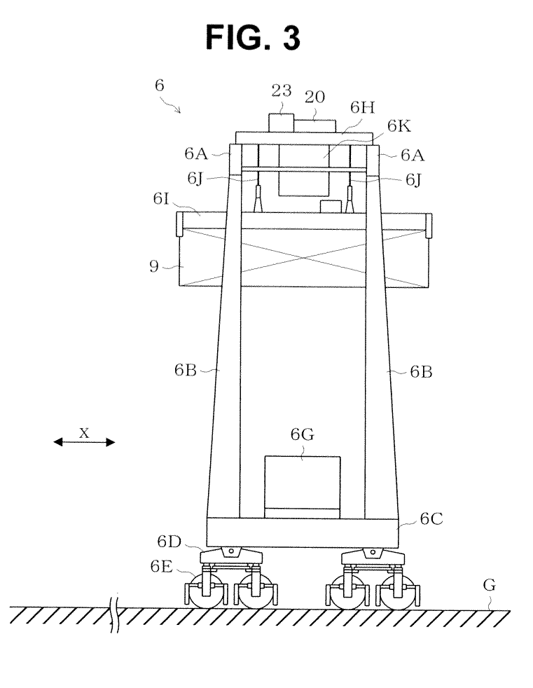

The mechanical arrangement of the crane apparatus according to this embodiment will be described next with reference to FIGS. 2 and 3.

The crane apparatus 100 according to this embodiment includes a gantry 6 formed from a gate-shaped framework as a whole. The gantry 6 includes upper girders 6A, legs 6B that support the ends of the upper girders 6A, and bases 6C that support the legs 6B. Tires 6E are provided under the bases 6C via carriages 6D. The tires 6E are supported by the carriages 6D so as to freely change the traveling direction between the forward direction X along the lanes and the right-angled direction Y perpendicular to the lanes.

A device unit 6G for accommodating electric devices such as the feed device 1 and the power storage devices 41 and 42 is provided on the base 6C between the legs 6B.

A trolley 6H is provided on the upper girders 6A at the upper portion of the gantry 6. When the traversing motor 22 mounted on the trolley 6H is driven, the trolley 6H travels in the right-angled direction Y on the rails of the upper girders 6A. A spreader 6I for holding the upper portion of a container 9 hangs from the trolley 6H via cables 6J. When the main hoisting motor 20 mounted on the trolley 6H is driven to wind up and down the cables 6J, the spreader 6I lifts and lowers. An operator's cab 6K in which an operator gets in and electric devices such as the controller 5 are also provided on the trolley 6H.

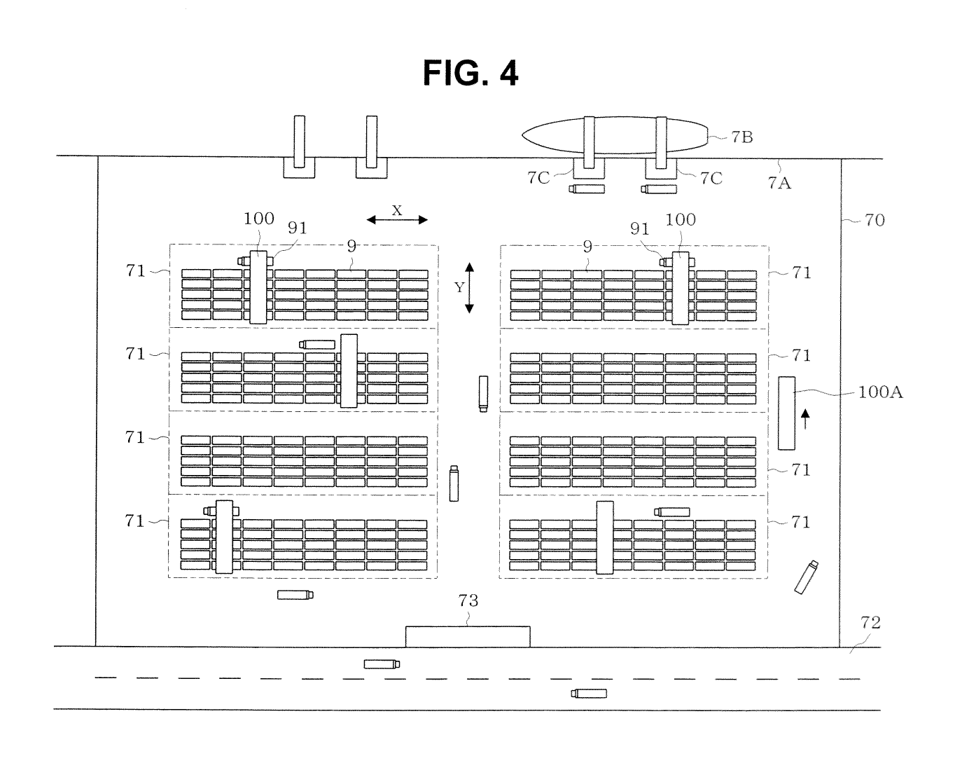

A container terminal where the crane apparatus according to this embodiment is used will be described next with reference to FIG. 4.

A container terminal 70 is located at a wharf 7A of a port, where container cranes 7C arranged at the wharf 7A load/unload the containers 9 on/from a ship 7B.

The container terminal 70 has a plurality of lanes 71 each formed from a rectangular area long in the longitudinal direction of the container 9, i.e., the forward direction X. The crane apparatus 100 travels within the lane 71 in the forward direction X, thereby efficiently assorting the containers 9 stacked in the lane 71.

The container terminal 70 has a gate 73 on the side of a road 72. A trailer 91 carries the container 9 in and out through the gate 73, or transports the container 9 to another place within the container terminal 70.

Each lane 71 has a passage for the trailer 91. The crane apparatus 100 loads/unloads the container 9 on/from the trailer 91 halted on the passage.

The crane apparatus 100 may be arranged in correspondence with each lane 71. However, moving the crane apparatus 100 to another lane 71 enables more efficient cargo handling. In this case, the gantry 6 is made to travel perpendicularly in the right-angled direction Y perpendicular to the forward direction X, like, for example, a crane apparatus 100A.

### Operation of First Embodiment

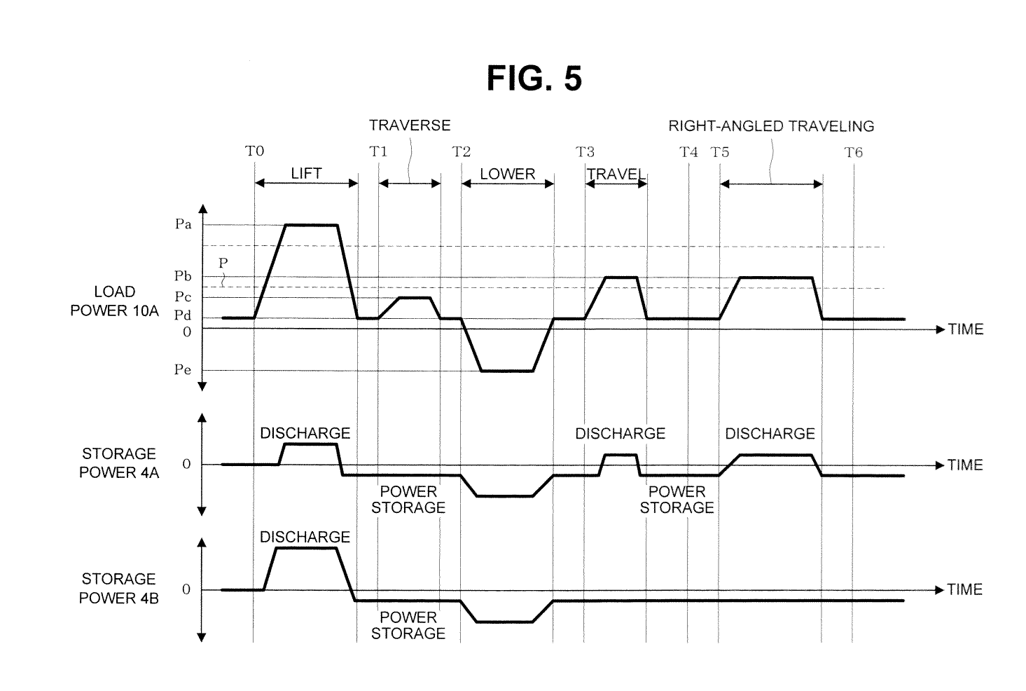

The operation of the crane apparatus according to the first embodiment of the present invention will be described next with reference to FIG. 5. An example will he explained here in which the crane apparatus 100 lifts the container 9, performs the traversing operation, lowers and lands the container 9, travels to an end of the lane 71, and then travels perpendicularly to move to another lane 71.

[Lifting Operation]

When the command 5A representing an instruction to lift the container 9 is input by an operator's operation at time T0, the controller 5 transmits the command 3A to the inverter 31 so as to instruct driving of the main hoisting motor 20. Since the main hoisting motor 20 thus rotates to start lifting the container 9, a load power 10A on the common bus 10 rises from a load power Pd used by the units of the crane apparatus 100 in the normal state to a maximum load power Pa. The controller 5 also outputs the command 4C in accordance with the command 5A representing the lifting instruction to instruct the power storage device 42 to start discharge.

On the other hand, the feed device 1 causes the diesel engine 11 to drive the DC generator 12 to generate a steady power P that is always constant, and outputs it as the supply power 1A. Hence, during the period the load power 10A is larger than the steady power P, the power storage devices 41 and 42 discharge storage powers 4A and 4B, respectively, to compensate for the shortage, and supply them to the main hoisting motor 20 via the common bus 10. At this time, the power storage devices 41 and 42 discharge the storage powers 4A and 45 corresponding to their characteristics to the common bus 10.

When the command 5A representing the instruction to lift the container 9 is then stopped, the inverter 31 stops driving the main hoisting motor 20 in accordance with the command 3A from the controller 5, and the load power 10A returns to the load power Pd. In addition, the controller 5 outputs the command 4C representing discharge stop in accordance with the stop of the command 5A representing the lifting instruction so as to stop discharge from the power storage device 42. Hence, part of the extra power is stored in the power storage devices 41 and 42 as the storage powers 4A and 4B during the period the load power 10A is smaller than the steady power P.

[Traversing Operation]

When the command 5A representing an instruction to make the container 9 traverse is input by an operator's operation at succeeding time T1, the controller 5 transmits the command 3A to the inverter 32 so as to instruct driving of the traversing motor 22. Since the traversing motor 22 thus rotates to start making the container 9 traverse, the load power 10A on the common bus 10 rises from the load power Pd in the normal state to a load power Pc. At this time, since the load power Pc is smaller than the steady power P, part of the extra power is stored in the power storage devices 41 and 42 as the storage powers 4A and 4B.

When the command 5A representing the container traversing instruction is then stopped, the inverter stops driving the traversing motor 22 in accordance with the command 3A from the controller 5, and the load power 10A returns to the load power Pd. Since the load power 10A is smaller than the steady power P, the power storage devices 41 and 42 continue to store the power.

[Lowering Operation]

When the command 5A representing an instruction to lower the container 9 is input by an operator's operation at next time T2, the controller 5 transmits the command 3A to the inverter 31 so as to instruct driving of the main hoisting motor 20. The main hoisting motor 20 thus rotates to start lowering the container 9. At this time, the main hoisting motor 20 receives a rotating force by the container weight, and generates a large regenerated power Pe. Hence, the regenerated power Pe is stored in the power storage devices 41 and 42 as the storage powers 4A and 4B.

When the command 5A representing the container lowering instruction is then stopped, the inverter 31 stops driving the main hoisting motor 20 in accordance with the command 3A from the controller 5, and the load power 10A returns to the load power Pd. Although the regenerated power Pe from the main hoisting motor 20 stops, the power storage devices 41 and 12 continue to store part of the extra power.

[Traveling Operation]

When the command 5A representing an instruction to make the gantry 6 travel is input by an operator's operation at succeeding time T3, the controller 5 transmits the command 3A to the inverter 31 so as to instruct driving of the traveling motor 21. Since the traveling motor 21 thus rotates to start making the gantry 6 travel along the lane, the load power 10A on the common bus 10 rises from the load power Pd in the normal state to a load power Pb. At this time, since the load power Pb is larger than the steady power P, the power storage device 41 discharges the storage power 4A to compensate for the shortage, and supplies it to the traveling motor 21 via the common bus 10. In this case, the controller 5 does not output the discharge start instruction to the power storage device 42. For this reason, for example, if the necessary power decreases after activating the motor, and a storable extra power exists on the common bus 10, part of it is stored in the power storage device 42 as the storage power 4B.

When the command 5A representing the gantry traveling instruction is then stopped, the inverter 31 stops driving the traveling motor 21 in accordance with the command 3A from the controller 5, and the load power 10A returns to the load power Pd. Since the load power 10A is smaller than the steady power P, the power storage devices 41 and 42 continue to store the power.

[Right-Angled Traveling Operation]

To move the crane apparatus 100 to another lane, the gantry 6 is made to travel to an end of the lane by the traveling operation. The carriages 6D rotate by 90° at time T4. Then, the gantry 6 is made to travel perpendicularly to another lane.

When the command 5A representing an instruction to make the gantry 6 perpendicularly travel is input by an operator's operation at succeeding time T5, the controller 5 transmits the command 3A to the inverter 31 so as to instruct driving of the traveling motor 21.

Since the traveling motor 21 thus rotates to start making the gantry 6 perpendicularly travel in the right-angled direction Y perpendicular to the lane, the load power 10A on the common bus 10 rises from the load power Pd in the normal state to the load power Pb. Since the load power Pb is larger than the steady power P, the power storage device 41 supplies the storage power 4A to the traveling motor 21 via the common bus 10 to compensate for the shortage. In this case, the controller 5 does not output the discharge start instruction to the power storage device 42. For this reason, for example, if the necessary power decreases after activating the motor, and a storable extra power exists on the common bus 10, part of it is stored in the power storage device 42 as the storage power 4B.

When the command 5A representing the instruction to make the gantry 6 travel perpendicularly then stopped, the inverter 31 stops driving the traveling motor 21 in accordance with the command 3A from the controller 5, and the load power 10A returns to the load power Pd.

After the gantry 6 thus travels perpendicularly to another lane, the carriages 6D rotate by 90° at time T6, and cargo handling starts in the new lane.

### Effects of First Embodiment

As described above, according to this embodiment, the power storage device (first power storage device) 41 stores part of the supply power 1A, and when the operating power decreases, discharges the storage power to compensate for the operating power. The power storage device (second power storage device) 42 stores part of the supply power 1A, and at least in the cargo lifting operation by the motor, discharges the storage power to compensate for the supply power 1A. A power storage device having an output density higher than that of the power storage device 41 is used as the power storage device 42. This allows the power storage device 42 to discharge a large storage power in a short time when lifting cargo.

The same functions as those of an arrangement using only the power storage device 41 can be implemented by the power storage devices 41 and 42 having a smaller volume. It is consequently possible to efficiently reduce the scale of the power supply system while suppressing an increase in the scale of the power storage devices.

When a power storage device having an energy density higher than that of the power storage device 42 is used as the power storage device 41, the power storage device 41 can stably discharge the storage power for a long time during a period except the period of cargo lifting operation.

The same functions as those of an arrangement using only the power storage device 42 can be implemented by the power storage device 41 having a smaller volume. It is consequently possible to efficiently reduce the scale of the power supply system while suppressing an increase in the scale of the power storage devices.

In this embodiment, the power storage device 42 discharges the storage power at least in the cargo lifting operation by the motor. For this reason, the storage power 4B of the power storage device 42 can preferentially be used during the period a large load is necessary in a short time so as to smoothly compensate for the supply power 1A.

In this embodiment, the feed device 1 supplies the supply power 1A by a DC power via the common bus. The first and second power storage devices are connected to the common bus so as to store part of the supply power 1A supplied to the common bus and discharge the storage power to the common bus. This enables to implement the power storage and discharge operations of the two power storage devices 41 and 42 by a very simple circuit connection arrangement.

In this embodiment, since the regenerated power generated by the main hoisting motor 20 in the container lowering operation is stored in the power storage devices 41 and 42, the storage powers 4A and 4B can efficiently be stored.

### Second Embodiment

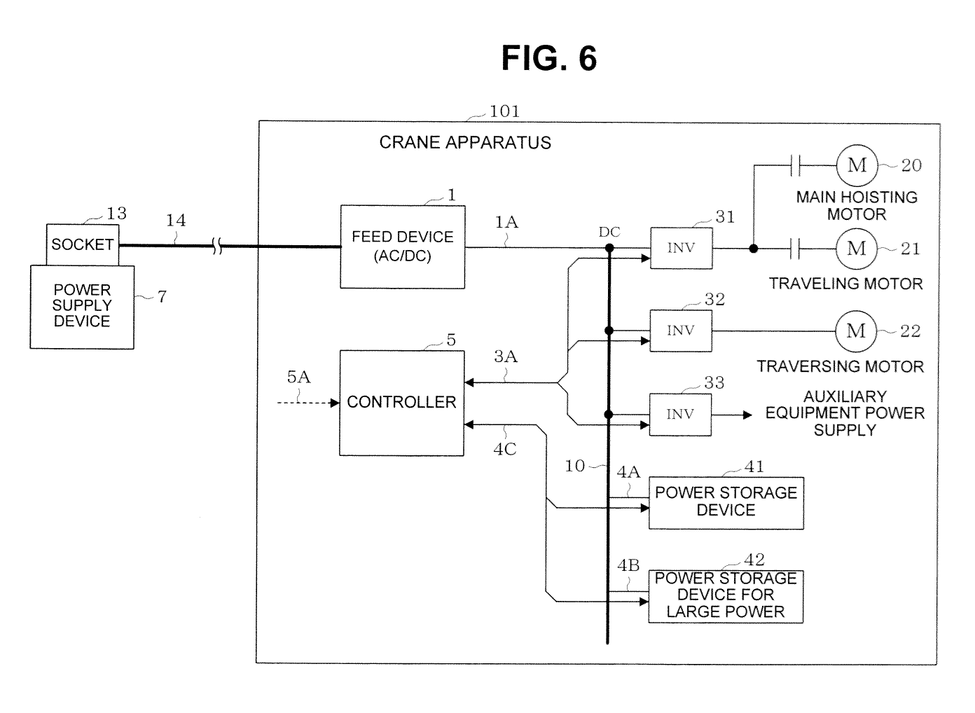

A crane apparatus according to the second embodiment of the present invention will be described next with reference to FIGS. 6 to 9.

In the first embodiment, an example has been described in which the feed device 1 is implemented by an engine generator. In the second embodiment, an example will be explained in which a power supplied from a power supply device 7 of a lane 71 via a power supply cable 14 is used as a supply power 1A for motors by a ground feed scheme.

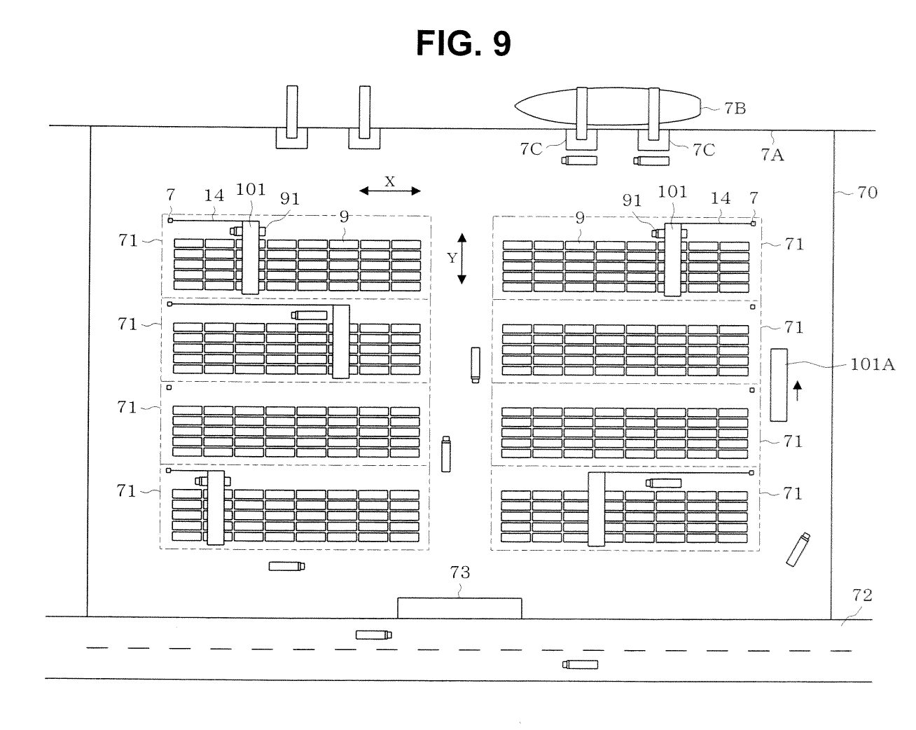

As shown in FIG. 6, a crane apparatus 101 according to this embodiment includes a feed device l formed from an AC/DC converter in place of the engine generator of the first embodiment. As shown in FIGS. 8 and 9, a feed power supplied from the power supply device 7 of the lane 71 is input to the feed device 1 via a socket 13 and the power supply cable 14.

The feed device 1 includes the AC/DC converter (not shown), and has a function of converting a source power supplied from the power supply device 7 into a DC power and supplying it to a common bus 10 as the supply power 1A. If the voltage of the source power is higher than that of the supply power 1A to be used by the crane apparatus 100, a transformer can be provided in the feed device 1 to lower the voltage.

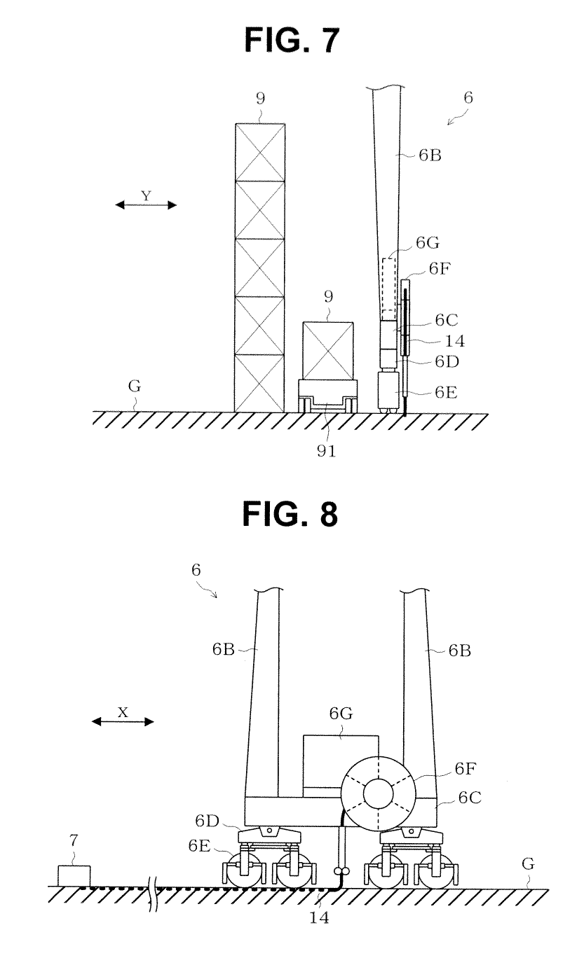

As shown in FIGS. 7 and 8, a cable reel 6F is provided on the outer side of a base 6C of a gantry 6 so as to unreel the power supply cable 14 as the gantry 6 travels in a forward direction X. An operator connects the power supply cable 14 in advance to the power supply device 7 arranged on ground G for the lane 71.

Note that the remaining components of the crane apparatus 101 according to this embodiment are the same as in the first embodiment, and a detailed description thereof will not be repeated here.

### Operation of Second Embodiment

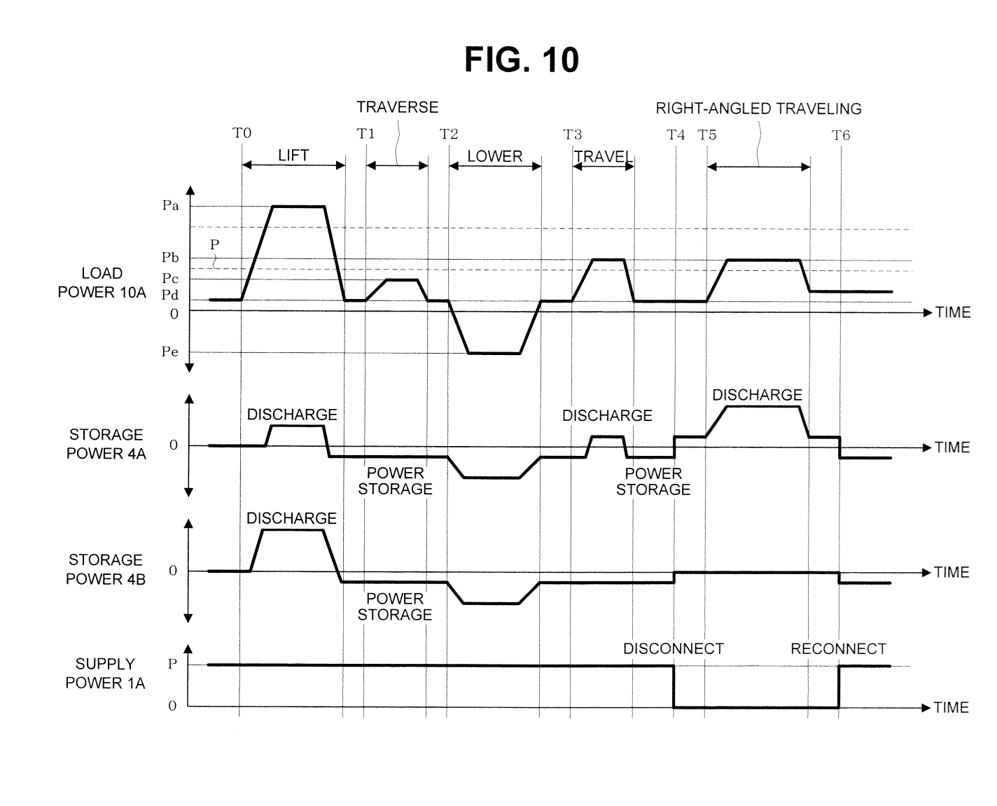

The operation of the crane apparatus according to the second embodiment of the present invention will be described next with reference to FIG. 10. An example will be explained here in which the crane apparatus 101 lifts a container 9, performs the traversing operation, lowers and lands the container 9, travels to an end of the lane 71, and then travels perpendicularly to move to another lane 71.

In the crane apparatus 101 as well, if the supply power 1A output from the feed device 1 to the common bus 10 has a surplus, power storage devices 41 and 42 store it as storage powers 4A and 4B in, for example, above-described traversing from time T1 in FIG. 5, traveling from time T3, and a standby state in which no crane operation is being performed, as in the first embodiment.

When performing the lifting operation, the storage powers 4A and 4B of the power storage devices 41 and 42 are supplied to a main hoisting motor 20 via the common bus 10 and an inverter 31 so as to compensate for the shortage of the supply power 1A. On the other hand, in the lowering operation, the storage powers 4A and 4B are stored in the power storage devices 41 and 42 based on a regenerated power output from the main hoisting motor 20 to the common bus 10 via the inverter 31. At this time, the regenerated power may be returned from the feed device 1 to the power supply device 7 via the power supply cable 14.

In the ground feed scheme, right-angled traveling is impossible when the power supply cable 14 of the crane apparatus 101 remains connected to the power supply device 7 provided in each lane 71. For this reason, after removing the socket 13 of the power supply cable 14 from the power supply device 7 at time T4, the operator performs a disconnecting operation to wind the power supply cable 14 on the cable reel 6F. When a command 5A representing an instruction to make the gantry 6 perpendicularly travel is input by an operator's operation at succeeding time T5, a controller 5 transmits a command 3A to the inverter 31 so as to instruct driving of a traveling motor 21.

In this case, ground feed to the crane apparatus 101 stops upon the disconnecting operation at time 14, and the supply power 1A supplied from the feed device 1 to the common bus 10 becomes zero. For this reason, the storage power 4A of the power storage device 41 is discharged and supplied to the common bus 10 or the traveling motor 21 via the inverter 31 in place of the supply power 1A.

Since the crane apparatus 101 is disconnected from the power supply device 7 on the ground in right-angled traveling, the storage power 4A of the power storage device 41 may be insufficient depending on the traveling distance or the magnitude of the load power to be consumed by the traveling motor 21 and the like. In this case, the controller 5 may instruct the power storage device 42 to supply the storage power 4B so as to compensate for shortage of the load power in right-angled traveling. At this time, the controller 5 outputs a command 4C based on input/stop of a command 5C representing a right-angled traveling instruction by an operator's operation, thereby instructing the power storage device 42 to start/end discharge.

Since the traveling motor 21 thus rotates to start making the gantry 6 perpendicularly travel in a right-angled direction Y perpendicular to the lane 71, a load power 10A on the common bus 10 rises from a load power Pd in the normal state to a load power Pb.

When the command 5A representing the instruction to make the gantry 6 travel perpendicularly is then stopped, the inverter 31 stops driving the traveling motor 21 in accordance with the command 3A from the controller 5, and the load power 10A returns to the load power Pd.

After the gantry 6 thus travels perpendicularly to another lane, a reconnecting operation is performed so that the operator unreels the power supply cable 14 from the cable reel 6F at time T6, and connects the socket 13 of the power supply cable 14 to the power supply device 7 of that lane.

Ground feed to the crane apparatus 101 is resumed in this way. The supply power 1A supplied from the feed device 1 to the common bus 10 returns up to a steady power P. In addition, part of the extra power is stored in the power storage devices 41 and 42 as the storage powers 4A and 4B.

Note that the remaining operations of the crane apparatus 101 according to this embodiment are the same as in the first embodiment, and a detailed description thereof will not be repeated here.

### Effects of Second Embodiment

As described above, even when the power supply device 7 on the ground supplies a power to the feed device 1 of the crane apparatus 101 via the power supply cable 14 by the ground feed scheme, the same functions and effects as in the first embodiment using the engine generator can be obtained. It is consequently possible to efficiently reduce the scale of the power supply system while suppressing an increase in the scale of the power storage devices. In addition, since the ground feed scheme is used, influence of exhaust or noise on the environment can be avoided.

### Third Embodiment

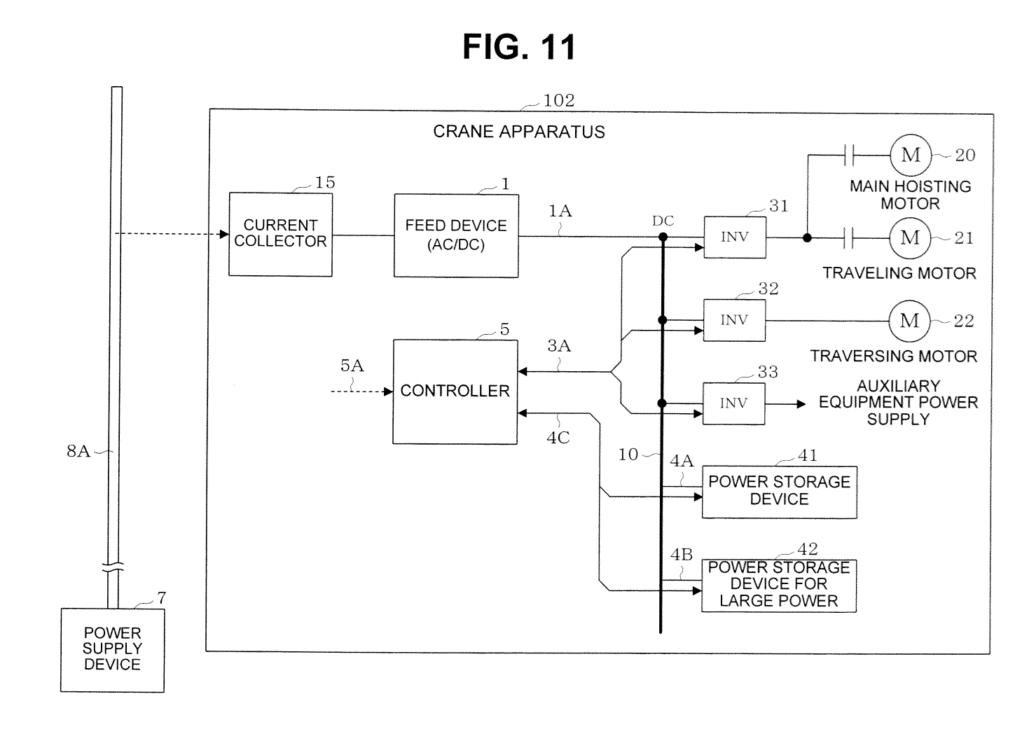

A crane apparatus according to the third embodiment of the present invention will be described next with reference to FIG. 11.

In the second embodiment, an example has been described in which a power supplied from the power supply device 7 of the lane 71 via the power supply cable 14 is used as the supply power 1A by a ground feed scheme. In the third embodiment, an example will be explained in which a power supplied from the power supply device of a lane is collected by a noncontact feed scheme and used as a supply power 1A by a ground feed scheme.

The electrical arrangement of the crane apparatus according to this embodiment will be described first with reference to FIG. 11.

A current collector 15 has a function of collecting, by a noncontact current collection scheme, a source power from a power supply device 7 provided in each lane 71 of a container terminal 70 via feed cables 8A laid along the lane 71. As the noncontact current collection scheme, a known technique using the electromagnetic induction function between a primary coil and a secondary coil is used. More specifically, the source power converted into a high frequency by the power supply device 7 is supplied to the feed cables 8A (primary coil) buried in ground G. A pickup coil (secondary coil) provided in the current collector 15 of a crane apparatus 102 is brought close to the feed cables 8A. A high-frequency current generated in the pickup coil is rectified, thereby obtaining a DC power.

A feed device 1 includes a DC/DC converter (not shown), and has a function of converting the DC power obtained by the current collector 15 into a stable DC power having a desired voltage and supplying it to a common bus 10 as a supply power 1A.

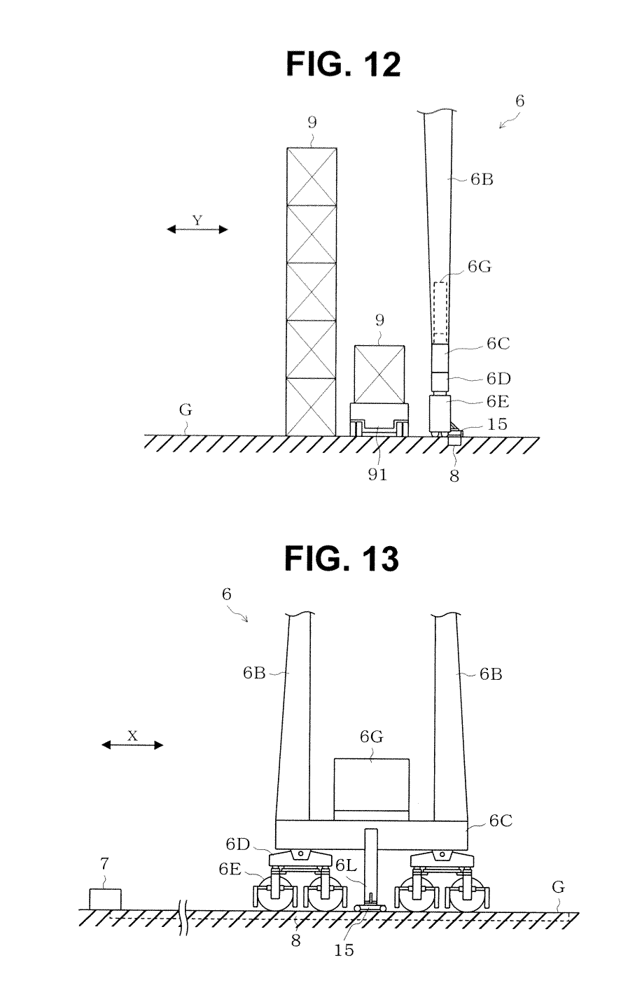

The mechanical arrangement of the crane apparatus according to this embodiment will be described next with reference to FIGS. 12 to 16.

As shown in FIGS. 12 and 13, the current collector 15 is attached, via a supporting member 6L and an arm 6M, to the outer side of a base 6C between two carriages 6D so as to face a current collection path 8 in the ground G. A feed power from the power supply device 7 is collected by the current collector 15 by the noncontact feed scheme and input to the feed device 1.

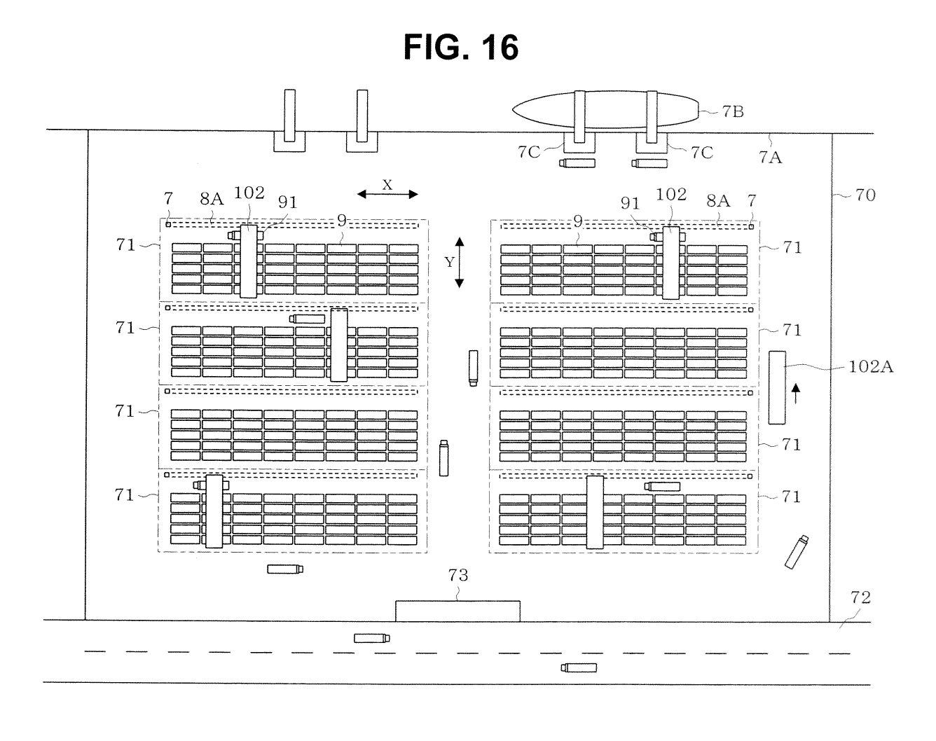

As shown in FIG. 16, each lane 71 of the container terminal 70 has the power supply device 7 that supplies a power to the crane apparatus 102. A source power from the power supply device 7 is supplied to the crane apparatus 102 via the feed cables 8A in a noncontact state.

The current collection path 8 includes a groove 8B formed along the lane 71, and the two feed cables 8A buried in an insulating material such as concrete or a resin filling the groove 8B. The feed cables 8A are connected to each other at the far ends so as to form the primary coil of the noncontact feed scheme.

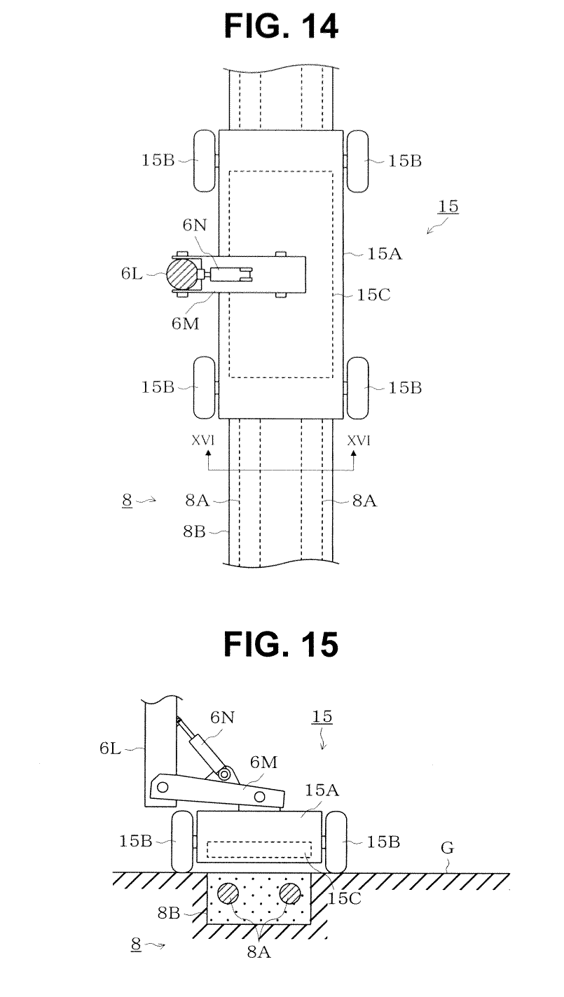

As shown in FIGS. 14 and 15, the current collector 15 includes a box-shaped main body 15A incorporating a pickup coil 15C, and four tires 15B rotatably attached to the four corners on the outer sides of the main body 15A. The arm 6M has one end rotatably attached to an end of the supporting member 6L, and the other end rotatably attached to the top of the main body 15A. A hydraulic cylinder 6N has one end rotatably attached to a side of the supporting member 6L, and the other end rotatably attached to almost the midpoint of the arm 6M. When the hydraulic cylinder 6N is operated, the arm 6M moves up/down so that the current collector 15 generates a predetermined press force against the ground G. Hence, even when the ground G is rough, or the crane apparatus 102 sways, the current collector 15 can be held on the current collection path 8.

### Operation of Second Embodiment

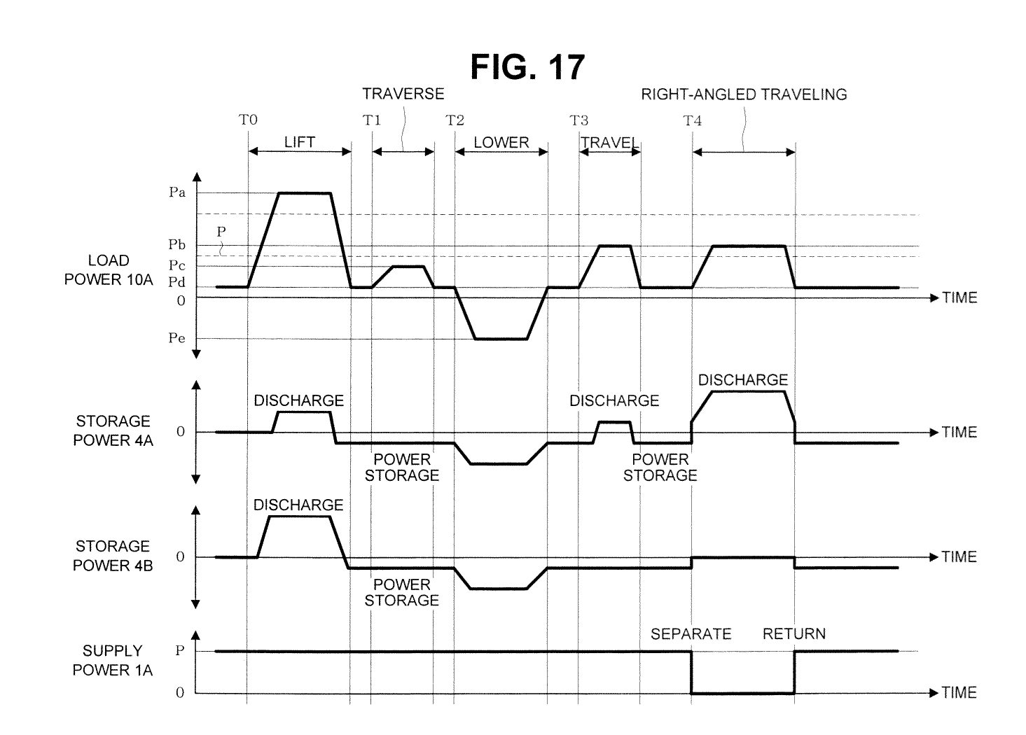

The operation of the crane apparatus according to the third embodiment of the present invention will be described next with reference to FIG. 17. An example will be explained here in which the crane apparatus 102 lifts a container 9, performs the traversing operation, lowers and lands the container 9, travels to an end of the lane 71, and then travels perpendicularly to move to another lane 71.

In the crane apparatus 102 as well, if the supply power 1A output from the feed device 1 to the bus 10 has a plus, power storage devices 41 and 42 store it as storage powers 4A and 4B example, above-described traversing from time T1 in FIG. 5, traveling from time T3, and a standby state in which no crane operation is being performed, as in the first embodiment.

When performing the lifting operation, the storage powers 4A and 40 of the power storage devices 41 and 42 are supplied to a main hoisting motor 20 via the common bus 10 and an inverter 31 so as to compensate for the shortage of the supply power 1A. On the other hand, in the lowering operation, the storage powers 4A and 4B are stored in the power storage devices 41 and 42 based on a regenerated power output from the main hoisting motor 20 to the common bus 10 via the inverter 31. At this time, the regenerated power may be returned from the feed device 1 to the power supply device 7 via a power supply cable 14.

In the noncontact feed scheme, after a gantry 6 travels to an end of the lane 71 by the traveling operation, the carriages 6D rotate by 90° so as to make the gantry 6 perpendicularly travel to another lane.

When a command 5A representing an instruction to make the gantry 6 perpendicularly travel is input by an operator's operation at time T4, a controller 5 transmits a command 3A to the inverter 31 so as to instruct driving of a traveling motor 21.

When the gantry 6 starts perpendicularly traveling accordingly, the current collector 15 of the crane apparatus 102 leaves the current collection path 8 provided on the lane 71. Ground feed stops, and the supply power 1A supplied from the feed device 1 to the common bus 10 becomes zero. For this reason, the storage power 4A of the power storage device 41 is discharged and supplied to the common bus 10 or the traveling motor 21 via the inverter 31 in place of the supply power 1A.

Since the crane apparatus 102 is disconnected from the power supply device 7 on the ground in right-angled traveling, the storage power 4A of the power storage device 41 may be insufficient depending on the traveling distance or the magnitude of the load power to be consumed by the traveling motor 21 and the like. In this case, the controller 5 may instruct the power storage device 42 to supply the storage power 4B so as to compensate for shortage of the load power in right-angled traveling. At this time, the controller 5 outputs a command 4C based on input/stop of a command 5C representing a right-angled traveling instruction by an operator's operation, thereby instructing the power storage device 42 to start/end discharge.

Since the traveling motor 21 thus rotates to start making the gantry 6 perpendicularly travel in a right-angled direction Y perpendicular to the lane 71, a load power 10A on the common bus 10 rises from a load power Pd in the normal state to a load power Pb.

After that, when the gantry 6 perpendicularly travels to the new lane 71, and returns to the position where the current collector 15 can collect the source power from the current collection path 8 of the lane 71, the command 5A representing the right-angled traveling instruction is stopped. The inverter 31 stops driving the traveling motor 21 in accordance with the command 3A from the controller 5, and the load power 10A returns the load power Pd.

Ground feed to the crane apparatus 102 is resumed in this way. The supply power 1A supplied from the feed device 1 to the common bus 10 returns up to a steady power P. In addition, part of the extra power is stored in the power storage devices 41 and 42 as the storage powers 4A and 4B.

### Effects of Third Embodiment

As described above, even when the power supply device 7 on the ground supplies a power to the feed device 1 of the crane apparatus 102 via the current collector 15 in the noncontact state by the ground feed scheme, the same functions and effects as in the first embodiment using the engine generator can be obtained. It is consequently possible to efficiently reduce the scale of the power supply system while suppressing an increase in the scale of the power storage devices. In addition, since the ground feed scheme is used, influence of exhaust or noise on the environment can be avoided.

### Fourth Embodiment

A crane apparatus according to the fourth embodiment of the present invention will be described next.

In the above-described second and third embodiments, an example has been described in which the crane apparatus is always connected to the power supply device 7 on the ground G so that the motors are driven by the source power from the power supply device 7. In the fourth embodiment, a case will be described in which in an inoperative state, for example, before the start of operation or after the end of operation, the crane apparatus is connected to a power supply device 7 to make power storage devices 41 and 42 to store a source power from the power supply device 7, and in an operating state, the crane apparatus is disconnected from the power supply device 7 so that the motors are driven by only the storage powers from the power storage devices 41 and 42.

The crane apparatus according to the fourth embodiment of the present invention is applied to the crane apparatuses 101 and 102 of the above-described second and third embodiments. A feed device 1 has a function of supplying a source power supplied from the power supply device 7 on ground. G to a common bus 10 as a supply power 1A to be used for power storage of the power storage devices 41 and 42 when the crane apparatus is in an inoperative state.

A controller 5 has an inoperative power storage control function of outputting a command 4C to the power storage devices 41 and 42 in accordance with a power storage instruction by an operator's operation when the crane apparatus is in the inoperative state so as to instruct an inoperative power storage operation of causing the power storage devices 41 and 42 to store the supply power 1A supplied from the feed device 1 to the common bus 10, and a discharge control function of outputting the command 4C to the power storage device 42 upon detecting input and input stop of a command 5A representing various kinds of operation instructions of cargo lifting/lowering, gantry traveling, traversing, right-angled traveling, and the like by an operator's operation so as to instruct discharge start (discharge permission) and discharge stop.

Hence, in the inoperative power storage operation, the power storage device 41 stores the operating power 1A from the feed device 1 as the storage power 4A in accordance with the command 4C corresponding to the inoperative power storage control function or discharge control function of the controller 5. In the cargo lowering operation, the power storage device 41 stores a regenerated power generated by a main hoisting motor 20 as the storage power 4A. The power storage device 41 discharges the storage power 4A during an operation period other than the regenerated power generation time, i.e., during the periods of cargo lifting, gantry traveling, traversing, right-angled traveling, and standby where the operations are stopped.

Hence, in the inoperative power storage operation, the power storage device 42 stores the operating power 1A from the feed device 1 as a storage power 4B in accordance with the command 4C corresponding to the inoperative power storage control function or discharge control function of the controller 5. The power storage device 42 stores, as the storage power 4B, the power supplied to the common bus 10 until the storage power voltage reaches a predetermined threshold voltage, for example, the storage power 4A from the power storage device 41 or the regenerated power generated by the main hoisting motor 20 during all operation periods except the period of cargo lifting, and discharges the storage power 4B in cargo lifting.

The arrangement is the same as that of the crane apparatus 101 (FIG. 6) of the above-described second embodiment or the crane apparatus 102 (FIG. 11) of the above-described third embodiment, and a description thereof will not be repeated here.

### Operation of Fourth Embodiment

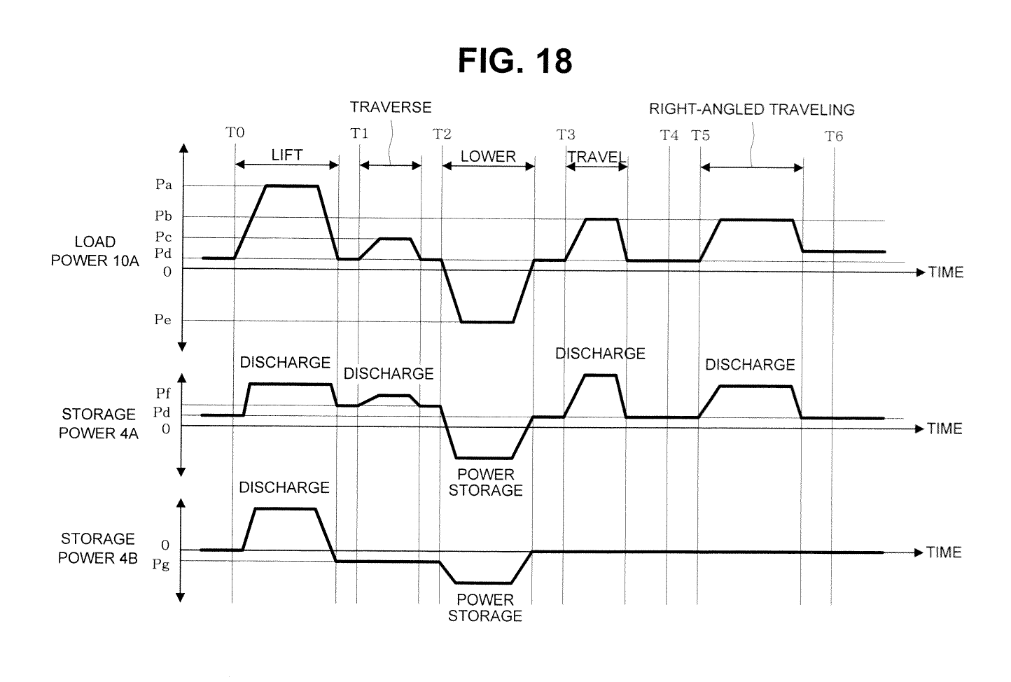

The operation of the crane apparatus according to the fourth embodiment of the present invention will be described next with reference to FIG. 18. An example will be explained here in which a crane apparatus 100 lifts a container 9, performs the traversing operation, lowers and lands the container 9, travels to an end of a lane 71, and then travels perpendicularly to move to another lane 71.

[Inoperative Power Storage Operation]

Before the start of operation or after the end of operation, the feed device 1 is connected to the power supply device 7 on the ground G via a power supply cable 14 (FIG. 6) or a current collector 15 so as to convert the source power from the power supply device 7 into the DC operating power 1A and supply it to the common bus 10. In accordance with the command 4C from the controller 5 corresponding to a power storage start instruction by an operator's operation, the power storage devices 41 and 42 store the operating power 1A supplied to the common bus 10. In this way, the storage powers 4A and 4B necessary for the next operation are stored in the power storage devices 41 and 42. The power storage ends in accordance with the command 4C from the controller 5 corresponding to a power storage end instruction by an operator's operation, and the feed device 1 is disconnected from the power supply device 7.

[Lifting Operation]

After the power storage devices 41 and 42 have sufficiently stored power in this way, the operation starts When the command 5A representing an instruction to lift the container 9 is input by an operator's operation at time T0, the controller 5 transmits a command 3A to an inverter 31 so as to instruct driving of the main, hoisting motor 20. Since the main hoisting motor 20 thus rotates to start lifting the container 9, a load power 10A on the common bus 10 rises from a load power Pd used by the units of the crane apparatus 100 in the normal state to a maximum load power Pa. In accordance with the increase in the load power 10A, the power storage device 41 supplies the storage power 4A to the common bus 10 and then to the main hoisting motor 20 via the inverter 31.

The controller 5 also outputs the command 4C in accordance with the lifting instruction to instruct the power storage device 42 to start discharge. Accordingly, the power storage device 42 supplies the storage power 4B to the common bus 10 and then to the main hoisting motor 20 via the inverter 31. Hence, in the operation of lifting the container 9, both the power storage devices 41 and 42 supply the storage powers 4A and 4B to the common bus 10 and then to the main hoisting motor 20 via the inverter 31.

When the command 5A representing the instruction to lift the container 9 is then stopped, the inverter 31 stops driving the main hoisting motor 20 in accordance with the command 3A from the controller 5, and the load power 10A returns to the load power Pd. In addition, the controller 5 outputs the command 4C representing discharge stop in accordance with the stop of the command 5A representing the lifting instruction so as to stop discharge from the power storage device 42

At this time, if the storage power voltage of the power storage device 42 drops below a threshold as the storage power 4B is discharged in the lifting operation, the power storage device 42 starts storing the storage power 4B corresponding to a load power Pg. Hence, the power storage device 41 discharges the storage power 4A corresponding to a load power Pf that is the sum of the load power Pd in the normal state and the storage load power Pg. Note that when the storage power voltage of the power storage device 42 becomes equal to or more than the threshold, power storage of the storage power 4B in the power storage device 42 automatically stops.

[Traversing Operation]

When the command 5A representing an instruction to make the container 9 traverse is input by an operator's operation at succeeding time T1, the controller 5 transmits the command 3A to an inverter 32 so as to instruct driving of a traversing motor 22. Since the traversing motor 22 thus rotates to start making the container 9 traverse, the load power 10A on the common bus 10 rises from the load power Pd in the normal state to a load power Pc. At this time, since the controller 5 does riot instruct the power storage device 42 to start discharge, only the power storage device 41 supplies the storage power 4A corresponding to the sum of the load power Pc and the storage load power Pg to the common bus 10 and then to the traversing motor 22 via the inverter 32 in accordance with the increase in the load power 10A.

When the command 5A representing the container traversing instruction is then stopped, the inverter 32 stops driving the traversing motor 22 in accordance with the command 3A from the controller 5, and the load power 10A returns to the load power Pd. In this example, since the power storage device 42 continues to store the storage power 4B, the power storage device 41 discharges the storage power 4A corresponding to the load power Pf.

[Lowering Operation]

When the command 5A representing a container lowering instruction is input by an operator's operation at next time T2, the controller 5 transmits the command 3A to the inverter 31 so as to instruct driving of the main hoisting motor 20. The main hoisting motor 20 thus rotates to start lowering the container 9. At this time, the main hoisting motor 20 receives a rotating force by the container weight, and generates a large regenerated power Pe.

At this time, since voltage of the common bus 10 is higher than the storage power voltage, the power storage devices 41 and 42 store the regenerated power Pe as the storage powers 4A and 4B during the period of this state until the storage power voltage reaches a predetermined threshold.

Note that a general power storage/discharge controller is provided in each of the power storage devices 41 and 42. In a full charge state where the storage power 4A has reached a predetermined storage amount, power storage in the power storage device 4 stops. The excess regenerated power Pe generated by stopping power storage is processed by, for example, converting it into heat energy by a resistor.

When the command 5A representing the container lowering instruction is then stopped, the inverter 31 stops driving the main hoisting motor 20 in accordance with the command 3A from the controller 5, and the load power 10A returns to the load power Pd. Since the voltage of the common bus 10 is lower than the storage power voltage, power storage ends in the power storage device 41. When the storage power voltage of the power storage device 42 becomes equal to or more than the threshold, power storage of the storage power 4B in the power storage device 42 automatically stops. In this example, since the storage power voltage is equal to or more than the threshold because of the regenerated power, and the storage power 4B is sufficiently stored, power storage ends. Hence, the power storage device 41 discharges the storage power 4A corresponding to the load power Pd in the normal state in accordance with the stop of power storage in the power storage device 42.

[Traveling Operation]

When the command 5A representing an instruction to make a gantry 6 travel is input by an operator's operation at succeeding time T3, the controller 5 transmits the command 3A to the inverter 31 so as to instruct driving of the traveling motor 21. Since the traveling motor 21 thus rotates to start making the gantry 6 travel along the lane, the load power 10A on the common bus 10 rises from the load power Pd in the normal state to a load power Pb. At this time, since the controller 5 does not instruct the power storage device 42 to start discharge, only the power storage device 41 supplies the storage power 4A corresponding to the load power Pb to the common bus 10 and then to the traveling motor 21 via the inverter 31 in accordance with the increase in the load power 10A.

When the command 5A representing the gantry traveling instruction is then stopped, the inverter 31 stops driving the traveling motor 21 in accordance with the command 3A from the controller 5, and the load power 10A returns to the load power Pd. Hence, the power storage device 41 discharges the storage power 4A corresponding to the load, power Pd in the normal state.

[Right-Angled Traveling Operation]

To move the crane apparatus 100 to another lane, the gantry 6 is made to travel to an end of the lane by the traveling operation. Carriages 6D rotate by 90° at time T4. Then, the gantry 6 is made to travel perpendicularly to another lane.

When the command 5A representing an instruction to make the gantry 6 perpendicularly travel is input by an operator's operation at succeeding time T5, the controller 5 transmits the command 3A to the inverter 31 so as to instruct driving of the traveling motor 21.

Since the traveling motor 21 thus rotates to start making the gantry 6 perpendicularly travel in a right-angled direction Y perpendicular to the lane, the load power 10A on the common bus 10 rises from the load power Pd in the normal state to the load power Pb. At this time, since the controller 5 does not instruct the power storage device 42 to start discharge, only the power storage device 41 supplies the storage power 4A corresponding to the load power Pb to the common bus 10 and then to the traveling motor 21 via the inverter 31 in accordance with the increase in the load power 10A.

When the command 5A representing the instruction to make the gantry 6 travel perpendicular is then stopped, the inverter 31 stops driving the traveling motor 21 in accordance with the command 3A from the controller 5, and the load power 10A returns to the load power Pd. Hence, the power storage device 41 discharges the storage power 4A corresponding to the load power Pd in the normal state.

After the gantry 6 thus travels perpendicularly to another lane, the carriages 6D rotate by 90° at time T6, and cargo handling starts in the new lane.

### Effects of Fourth Embodiment

As described above, according to this embodiment, the crane apparatus in an inoperative state is connected to the power supply device 7 installed on the ground, and the feed device 1 supplies the source power from the power supply device 7 as the supply power 1A. When operating, the crane apparatus is disconnected from the power supply device to stop supplying the supply power 1A. It is therefore possible to drive the motors by only the power storage devices 41 and 42 when operating the crane apparatus without requiring engine generation or ground feed.

When a power storage device having an output density higher than that of the power storage device 41 is used as the power storage device 42, the power storage device 42 can discharge a large storage power in a short time when lifting cargo. The same functions as those of an arrangement using only the power storage device 41 can be implemented by the power storage devices 41 and 42 having a smaller volume. It is consequently possible to efficiently reduce the scale of the power supply system while suppressing an increase in the scale of the power storage devices.

When a power storage device having an energy density higher than that of the power storage device 42 is used as the power storage device 41, the power storage device 41 can stably discharge the storage power for a long time during a period except the period of cargo lifting operation. The same functions as those of an arrangement using only the power storage device 42 can be implemented by the power storage device 41 having a smaller volume. It is consequently possible to efficiently reduce the scale of the power supply system while suppressing an increase in the scale of the power storage devices.

### Extension of Embodiments

In the above embodiments, an example has been described in which extra power of the supply power 1A or regenerated power is partially or wholly stored in the power storage device 42 as the storage power 4B, and the storage power 4B from the power storage device 42 compensates for power shortage only in the cargo lifting operation, as shown in FIGS. 5, 10, and 17. If a large power is necessary in an operation other than the cargo lifting operation, the controller 5 may output the command 4C to make the power storage device 42 discharge the storage power 4B, as in the cargo lifting operation.

In the above embodiments, an example has been described in which the discharge timing of the power storage device 42 is controlled by detecting input of the command 5A representing the discharge start or discharge stop by an operator's operation. However, a load detection unit may be provided on the common bus 10 to monitor the voltage of the supply power 1A from the feed device 1. It is determined, based on whether the voltage of the supply power 1A is lower than a predetermined threshold, whether a large load is generated by the cargo lifting operation or the like. The power storage device 42 starts discharging the storage power 4B based on load generation determination of the load detection unit, and stops discharging the storage power 4B based on load end determination of the load detection unit.

Each of the power storage devices 41 and 42 of the embodiments includes a general power storage/discharge controller. The power storage/discharge controller controls the following power storage/discharge operations other than power storage/discharge control by the controller 5. For example, the power storage devices 41 and 42 start power storage when the voltage of the common bus 10 is higher than the storage power voltage, and then stop power storage in a full charge state where the storage power voltage has reached a predetermined threshold voltage. The power storage device 41 discharges the storage power 4A to the common bus 10 during the period the voltage of the common bus 10 is lower than the storage power voltage. Note that the excess regenerated power Pe generated by stopping power storage is processed by, for example, converting it into heat energy by a resistor. Note that all the power storage/discharge controls may be done by the controller 5 without providing the power storage/discharge controller in the power storage devices 41 and 42.

In the fourth embodiment, the controller 5 may detect the storage power voltages of the power storage devices 41 and 42 in accordance with a feed end instruction by an operator's operation in the inoperative power storage operation. If the storage power voltages are lower than a predetermined threshold, and the storage powers 4A and 4B are short, the operator may be notified of it by causing a screen display unit or lamp provided on the controller 5 to given an alarm.

This allows the operator to input a feed start instruction again by an operator's operation to continue power storage, or appropriately cope with insufficient storage of the storage powers 4A and 4B.

In the fourth embodiment, the controller 5 may monitor the storage power voltages of the power storage devices 41 and 42 during the operation of the crane apparatus, and output an alarm when the storage power voltages drop below a predetermined threshold to notify the operator of the decrease in the storage powers 4A and 4B.

This allows the operator to appropriately cope with it by, for example, connecting the crane apparatus to the power supply device 7 in the vicinity and storing the power obtained from the power supply device 7 via the feed device 1 as the storage powers 4A and 4B. It is therefore possible to reliably prevent the crane apparatus from getting stuck due to the decrease in the storage powers 4A and 4B.

### INDUSTRIAL APPLICABILITY

The crane apparatus is useful as a crane apparatus that drives the motors by a source power generated by an engine generator using a diesel engine and storage power obtained by storing the source power, for example, a gantry crane apparatus for performing cargo handling to, e.g., load/unload containers on/from a ship or trailer at a container terminal.

1. A crane apparatus for loading/unloading cargo by driving a plurality of motors, comprising:
a feed device which supplies, as a supply power, a power to be used for an operation of the crane apparatus;
a first power storage device which stores part of the supply power and discharges the storage power when driving the motors; and
a second power storage device which stores part of the supply power and discharges the storage power when driving the motors at least for cargo lifting,
wherein said second power storage device has an output density higher than that of said first power storage device.

2. A crane apparatus according to claim 1, wherein
said feed device supplies the supply power by a DC power via a common bus, and
said first power storage device and said second power storage device are connected to the common bus so as to store part of the supply power supplied to the common bus and discharge the storage power to the common bus.

3. A crane apparatus according to claim 1, further comprising a controller which controls operations of the motors based on input commands representing various crane operations,
said, controller instructing said second power storage device to discharge the storage power based on an input command representing cargo lifting.

4. A crane apparatus for loading/unloading cargo by driving a plurality of motors, comprising:
a feed device which supplies, as a supply power, a power to be used for an operation of the crane apparatus;
a first power storage device which stores part of the supply power and discharges the storage power when driving the motors; and
a second power storage device which stores part of the supply power and discharges the storage power when driving the motors at least for cargo lifting,
wherein said first power storage device has an energy density higher than that of said second power storage device.

5. A crane apparatus according to claim 4, wherein
said feed device supplies the supply power by a DC power via a common bus, and
said first power storage device and said second power storage device are connected to the common bus so as to store part of the supply power supplied to the common bus and discharge the storage power to the common bus.

6. A crane apparatus according to claim 4, further comprising a controller which controls operations of the motors based on input commands representing various crane operations,
said controller instructing said second power storage device to discharge the storage power based on an input command representing cargo lifting.
